(19) United States
(12) Patent Application Publication
(10) Pub. No.: US 2007/0248890 A1
(43) Pub. Date: Oct. 25, 2007

(54) Index Contrasting-Photoactive Polymerizable Materials, and Articles and Methods Using Same

(75) Inventors: Michael C. Cole, Longmont, CO (US); Fredric R. Askham, Loveland, CO (US); Timothy J. Trentler, Longmont, CO (US)

Correspondence Address: JAGTIANI + GUTTAG, 10363-A DEMOCRACY LANE, FAIRFAX, VA, 22030, US

(73) Assignee: InPhase Technologies, Inc., Longmont, CO (US)

(21) Appl. No.: 11/738,394

(22) Filed: Apr. 20, 2007

Related U.S. Application Data
(60) Provisional application No. 60/793,322, filed on Apr. 20, 2006.

(51) Int. Cl. G03H 1/04

(52) U.S. Cl. 430/1; 430/2; 359/3

(57) ABSTRACT

The present invention provides a composition comprising at least one a photoactive index-contrasting polymerizable material, wherein the photoactive polymerizable material comprises at least one reactive functional group and at least one index-contrasting group, and wherein the photoactive polymerizable material includes one or more of the following parameters: (1) a distance between at least one reactive group and at least one index-contrasting group which is at least to the average radius of the index-contrasting group; (2) two or more reactive groups per photoactive polymerizable materials; (3) an index-contrasting group having a strong chromophore absorption at a wavelength shorter than the recording wavelength, and (4) the photoactive polymerizable material comprises a reactive nanoparticle. The photoactive polymerizable material may be used to prepare an article by, for example, dispersion thereof in a support matrix, which may be used, for example, to record holograms.

### CROSS-REFERENCE TO RELATED APPLICATIONS

This application makes reference to and claims the priority date of co-pending U.S. Provisional Patent Application No. 60/793,322, entitled “A Method for Designing Index Contrasting Monomers” filed Apr. 20, 2006. The entire disclosure and contents of the above application is hereby incorporated by reference.

### BACKGROUND

1. Field of the Invention

The present invention relates generally to index-contrasting photoactive polymerizable materials for use in holography and other related fields. The present invention also relates generally to articles comprising such photoactive polymerizable materials present in a support matrix. The present invention further relates generally to recording holograms with such articles.

2. Related Art

Developers of information storage devices and methods continue to seek increased storage capacity. As part of this development, holographic memory systems have been suggested as alternatives to conventional memory devices. Holographic memory systems may be designed to record data as one bit of information (i.e., bit-wise data storage). See McLeod et al. “Micro-Holographic Multi-Layer Optical Disk Data Storage,” International Symposium on Optical Memory and Optical Data Storage (July 2005). Holographic memory systems may also be designed to record an array of data that may be a 1-dimensional linear array (i.e., a 1×N array, where N is the number linear data bits), or a 2-dimension array commonly referred to as a “page-wise” memory system. Page-wise memory systems may involve the storage and readout of an entire two-dimensional representation, e.g., a page of data. Typically, recording light passes through a two-dimensional array of low and high transparency areas representing data, and the system stores, in three dimensions, the pages of data holographically as patterns of varying refractive index imprinted into a storage medium. See Psaltis et al., “Holographic Memories,” Scientific American, November 1995, where holographic systems are discussed generally, including page-wise memory systems.

In a holographic data storage system, information is recorded by making changes to the physical (e.g., optical) and chemical characteristics of the holographic storage medium. These changes in the holographic medium take place in response to the local intensity of the recording light. That intensity is modulated by the interference between a data-bearing beam (the data beam) and a non-data-bearing beam (the reference beam). The pattern created by the interference of the data beam and the reference beam forms a hologram which may then be recorded in the holographic medium. If the data-bearing beam is encoded by passing the data beam through, for example, a spatial light modulator (SLM), the hologram(s) may be recorded in the holographic medium as an array of light and dark squares or pixels. The holographic medium or at least the recorded portion thereof with these arrays of light and dark pixels may be subsequently illuminated with a reference beam (sometimes referred to as a reconstruction beam) of the same or similar wavelength, phase, etc., so that the recorded data may be read.

One type of holographic storage medium used recently for such holographic data storage systems are photosensitive polymer films. Photosensitive polymer films are considered attractive recording media candidates for high density holographic data storage. These films have a relatively low cost, are easily processed and can be designed to have large index contrasts with high photosensitivity. These films may also be fabricated with the dynamic range, media thickness, optical quality and dimensional stability required for high density applications. See, e.g., L. Dhar et al., “Recording Media That Exhibit High Dynamic Range for Holographic Storage,” Optics Letters, 24, (1999): pp. 487 et. seq; Smothers et al., “Photopolymers for Holography,” SPIE OE/Laser Conference, (Los Angeles, Calif, 1990), pp.: 1212-03.

The holographic storage media described in Smothers et al., supra contain a photoimageable system containing a liquid monomer material (the photoactive monomer) and a photoinitiator (which promotes the polymerization of the monomer upon exposure to light), where the photoimageable system is in an organic polymer host matrix that is substantially inert to the exposure light. During writing (recording) of data into the holographic medium, the monomer polymerizes in the exposed regions. Due to the lowering of the monomer concentration caused by the polymerization, monomer from the dark, unexposed regions of the material diffuses to the exposed regions. The polymerization and resulting diffusion create a refractive index change, thus forming the hologram representing the data. An important aspect to these systems is the mass transport from one region to another to create a large change in refractive index, which may provide a distinct advantage over photochromic systems.

The characteristics and capabilities of the holographic storage medium may depend upon or be affected by a number of factors, and especially the nature, properties, composition, etc., of the holographic medium. For example, the optical and chemical characteristics of a holographic medium may affect how the medium absorbs different wavelengths of light, the speed with which a particular wavelength of light is absorbed, how well or uniformly the medium records the holograms with respect to the particular wavelength of light, etc. In addition, the recording characteristics of the holographic medium may change as the various chemical components present in the medium are used up or formed, as the medium ages over time, etc. All of these factors may affect and may make less optimal the characteristics and capabilities of the holographic medium to record and/or read data.

Designing molecules for index contrast applications such holographic storage medium, holographic optical elements, waveguides and photolithography have previously concentrated on the use of photoactive monomers comprising a single high index-contrasting group attached to a reactive vinyl group (such as an acrylate) or epoxide. Such monomers are described in, for example, U.S. Pat. No 5,759,721 (Dhal, et al.), issued Jun. 2, 1998; U.S. Pat. No 5,874,187 (Colvin, et al.), issued Feb. 23, 1999; U.S. Pat. No 6,103,454 (Dhar, et al.), issued Aug. 15, 2000; U.S. Pat. No 6,482,551 (Dhar, et al.), issued Nov. 19, 2002; and U.S. Pat. No 6,784,300 (Cetin, et al.), issued Aug. 31, 2004. Such monomers may form photopolymers having a high diffraction efficiency and high dynamic range.

There may, however, be other ways to improve the performance of photoactive monomers that form photopolymers having high diffraction efficiency, high dynamic range, as well as other desirable properties.

### SUMMARY

According to a first broad aspect of the present invention, there is provided a composition comprising at least one photoactive index-contrasting polymerizable material, wherein the photoactive polymerizable material comprises at least one reactive functional group and at least one index-contrasting group, and wherein the photoactive polymerizable material includes one or more of the following parameters: (1) a distance between at least one reactive group and at least one index-contrasting group which is at least to the average radius of the index-contrasting group; (2) two or more reactive groups per each molecule of photoactive polymerizable material; (3) an index-contrasting group having a strong chromophore absorption at a wavelength shorter than the recording wavelength, or (4) the photoactive polymerizable material comprises a reactive nanoparticle.

According to a second broad aspect of the invention, there is provided an article comprising a support matrix and at least one index-contrasting photoactive polymerizable material present in the support matrix, wherein the photoactive polymerizable material has an average index contrast of greater than about 0.1, a molecular size of at least about 1 nm in at least one spatial dimension, wherein the polymerizable material comprises at least one reactive functional group and at least one index-contrasting group, wherein the index-contrasting group is substantially absent from the support matrix, and wherein the photoactive polymerizable material includes one or more of the following parameters: (1) a distance between at least one reactive group and at least one index-contrasting group which is at least to the average radius of the index-contrasting group; (2) two or more reactive groups per each molecule of photoactive polymerizable material; (3) an index-contrasting group having a strong chromophore absorption at a wavelength shorter than the recording wavelength, or (4) the photoactive polymerizable material comprises a reactive nanoparticle.

According to a third broad aspect of the present invention, there is provided a method comprising the following steps:
a. providing an article comprising a holographic storage medium, wherein the holographic medium comprises: a support matrix, and at least one index-contrasting photoactive polymerizable material present in the support matrix, wherein the photoactive polymerizable material has an average index contrast of greater than about 0.1, a molecular size of at least about 1 nm in at least one spatial dimension, wherein the polymerizable material comprises at least one reactive functional group and at least one index-contrasting group, wherein the index-contrasting group is substantially absent from the support matrix, and wherein the photoactive polymerizable material includes one or more of the following parameters: (1) a distance between at least one reactive group and at least one index-contrasting group which is at least to the average radius of the index-contrasting group; (2) two or more reactive groups per each molecule of photoactive polymerizable material; (3) an index-contrasting group having a strong chromophore absorption at a wavelength shorter than the recording wavelength, or (4) the photoactive polymerizable material comprises a reactive nanoparticles; and
b. exposing the article to a photoinitiating light source to cause the photoactive polymerizable material to form a photopolymer to thereby record at least one hologram in the holographic medium.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “light source” refers to any source of electromagnetic radiation of any wavelength. The light source of the present invention may be from one or more lasers, one or more light emitting diodes (LEDs), etc. In some embodiments, the light source may have a wavelength of between about 200 nm and about 1000 nm.

For the purposes of the present invention, the term “photoinitiating light source” refers to a light source that activates a photoinitiator, a photoactive polymerizable material, or any combination thereof. Photointiating light sources may include recording light, etc.

For the purposes of the present invention, the term “spatial light intensity” refers to a light intensity distribution or pattern of varying light intensity within a given volume of space.

For the purposes of the present invention, the terms “holographic grating,” “holograph” or “hologram” (collectively and interchangeably referred to hereafter as “hologram”) are used in the conventional sense of referring to an interference pattern formed when a signal beam and a reference beam interfere with each other. In cases wherein data is recorded page-wise, the signal beam may be encoded with a data modulator, e.g., a spatial light modulator, to provide a data beam.

For the purposes of the present invention, the term “holographic recording” refers to a hologram after it is recorded in the holographic medium. The holographic recording may provide bit-wise storage (i.e., recording of one bit of data), may provide storage of a 1-dimensional linear array of data (i.e., a 1×N array, where N is the number linear data bits), or may provide 2-dimensional storage of a page of data. Holographic recording may be performed in a holographic storage medium with recording light.

For the purposes of the present invention, the term “holographic storage medium” refers to a component, material, etc., that is capable of recording and storing, in three dimensions (i.e., the X, Y and Z dimensions), one or more holograms (e.g., bit-wise, linear array-wise or page-wise) as one or more patterns of varying refractive index imprinted into the medium. The holographic storage medium (which may also be referred to interchangeably as a “holographic recording medium” or a “photoimageable system”) at least comprises a support matrix in which is dispersed at least one photoactive polymerizable material.

For the purposes of the present invention, the terms “dynamic range” or “M#” relate to an intrinsic property of a holographic medium and refer to the total response of that medium when portioned among the one or more holograms recorded in a common volume and related to the index change and thickness of that medium. See Shelby, “Media Requirements for Digital Holographic Data Storage,” Holographic Data Storage, Section 1.3 (Coufal, Psaltis, Sincerbox Eds. 2003).

For the purposes of the present invention, the term “diffraction efficiency” of a recorded hologram refers to the fraction of light refracted into a reconstructed object or reference beam by the recorded hologram when illuminated with a beam of light at the same or similar position, angle, wavelength, etc., to the object or reference beam used to record that hologram.

For the purposes of the present invention, the term “percentage of dynamic range used” refers to how much of the dynamic range of a holographic medium has been used, relative to the total dynamic range capacity of the medium. For example, assuming all multiplexed holograms overlapping in a given volume have an equal diffraction efficiency, M# and the diffraction efficiency (DE) may be related by the following equation: DE=(M#/n)², wherein n is the number of holograms multiplexed in that volume.

For the purposes of the present invention, the term “holographic data” refers to data stored in the holographic medium as one or more holograms.

For the purposes of the present invention, the term “data page” or “page” refers to the conventional meaning of data page as used with respect to holography. For example, a data page may be a page of data, one or more pictures, etc., to be recorded or recorded in a holographic medium. Data may also include images (e.g., display holograms).

For the purposes of the present invention, the term “recording light” refers to a light source used to record information, data, etc., into a holographic medium.

For the purposes of the present invention, the term “recording data” refers to writing or storing holographic data in a holographic medium.

For the purposes of the present invention, the term “reading data” refers to retrieving, recovering, or reconstructing holographic data stored in a holographic medium.

For the purposes of the present invention, the term “substrate” refers to components, materials, etc., such as, for example, glass plates or plastic plates, which are associated with the holographic medium, and which may provide a supporting structure for the holographic medium. Substrates may also optionally provide other beneficial properties for the article, e.g., rendering the holographic medium optically flat, providing a barrier to water vapor, providing a surface for antireflective coatings, etc.

For the purposes of the present invention, the term “support matrix” refers to a polymeric material, medium, substance, etc., which provides both an index contrast in recording and which also retains the recorded structures (archival stability). The support matrix may be a thermoplastic or a thermoset material. The support matrix may be formed separately and by different chemistries from the photoactive polymerizable material used to record holograms (e.g., two-component systems), as described in commonly-assigned U.S. Pat. No 6,482,551 (Dhar et al.), issued Nov. 19, 2002, the entire disclosure and contents of which is hereby incorporated by reference. The support matrix also contains substantially few to zero index-contrasting groups contained in the photoactive polymerizable material. The support matrix may be designed to allow the photoactive polymerizable material to diffuse through and to be miscible with/dispersible within the support matrix such that very little light scatter occurs (e.g., either before or after photopolymerization of the photoactive polymerizable material).

For the purposes of the present invention, the term “oligomer” refers to a polymer or polymerizable material having approximately 30 repeat units or less or any large molecule able to diffuse at least about 100 nm in approximately 2 minutes at room temperature when dissolved in a holographic medium of the present invention. When more than one polymerizable group is present on the oligomer, they may be the same or different. Additionally, oligomers may be dendritic. With reference to photopolymers, such oligomers may be the product or products of polymerization of monomers with about 30 or less repeating units, and may comprise residual unreacted functional groups and may be crosslinked. To avoid affecting archival stability of the photopolymer because of potential diffusion through or from the support matrix, photopolymer oligomers may be mechanically or covalently bonded to the support matrix.

For the purposes of the present invention, the term “photopolymerization” refers to any polymerization reaction caused by exposure to a photoinitiating light source.

For the purposes of the present invention, the term “free radical polymerization” refers to any polymerization reaction that is initiated by any molecule comprising a free radical or radicals.

For the purposes of the present invention, the term “cationic polymerization” refers to any polymerization reaction that is initiated by any molecule comprising a cationic moiety or moieties.

For the purposes of the present invention, the term “anionic polymerization” refers to any polymerization reaction that is initiated by any molecule comprising an anionic moiety or moieties.

For the purpose of the present invention, the term “photoinitiator” refers to the conventional meaning of the term photoinitiator and also refers to sensitizers and dyes. In general, a photoinitiator causes the light initiated polymerization of a material, such as a photoactive polymerizable material, when the photoinitiator is exposed to light of a wavelength that activates the photoinitiator, i.e., a photoinitiating light source. The photoinitiator may refer to a combination of components, some of which individually are not light sensitive, yet in combination are capable of initiating polymerization of a polymerizable material (e.g., a photoactive polymerizable material), examples of which may include a dye/amine, a sensitizer/iodonium salt, a dye/borate salt, etc. The term photoinitiator may also refer to a single photoinitiator or to a combination of two or more photoinitiators. For example, two or more photoinitiators may be used to allow recording at two or more different wavelengths of light.

For the purposes of the present invention, the term “photoactive polymerizable material” refers to a photoactive monomer, a photoactive oligomer or combinations thereof that polymerize when exposed to a photoinitiating light source, e.g., recording light, either in the presence or absence of a photoinitiator that has been activated by the photoinitiating light source. In reference to the reactive functional group that undergoes polymerization, the photoactive polymerizable material comprises at least one such reactive functional group. The photoactive polymerizable material also comprises at least one index-contrasting group. It is also understood that there exist photoactive polymerizable materials that may also comprise photoinitiators, such as, for example, N-methylmaleimide, acrylate derivatized acetophenones, etc. In such a case, it is understood that the photoactive polymerizable material may also be a photoinitiator.

For the purposes of the present invention, the term “photopolymer” refers to a polymer formed or resulting from the polymerization of one or more photoactive polymerizable materials, and possibly one or more additional monomers and/or oligomers.

For the purposes of the present invention, the term “thermoplastic” refers to the conventional meaning of thermoplastic, i.e., a composition, compound, material, medium, substance, etc., that exhibits the property of a material, such as a high polymer, that softens when exposed to heat and generally returns to its original condition when cooled to room temperature. Examples of thermoplastics include, but are not limited to: poly(vinyl acetate), poly(styrene), poly(ethylene), poly(propylene), cyclic olefin polymers, poly(ethylene oxide), linear nylons, linear polyesters, linear polycarbonates, linear polyurethanes, etc.

For the purposes of the present invention, the term “room temperature” refers to the commonly accepted meaning of room temperature, i.e., an ambient temperature of 20°-25° C.

For the purposes of the present invention, the term “thermoset” refers to the conventional meaning of thermoset, i.e., a composition, compound, material, medium, substance, etc., that is crosslinked such that it does not have a melting temperature, and cannot be dissolved in a solvent, but which may be swelled by a solvent. Examples of thermoset materials may include crosslinked poly(urethanes), crosslinked poly(acrylates), crosslinked poly(styrene), etc.

For the purposes of the present invention, the term “X-Y plane” typically refers to the plane defined by the substrates or the holographic medium that encompasses the X and Y linear directions or dimensions. The X and Y linear directions or dimensions are typically referred to herein, respectively, as the dimensions known as length (i.e., the X-dimension) and width (i.e., the Y-dimension).

For the purposes of the present invention, the terms “Z-direction” and “Z-dimension” refer interchangeably to the linear dimension or direction perpendicular to the X-Y plane, and is typically referred to herein as the linear dimension known as thickness.

For the purposes of the present invention, the term “index” refers interchangeably to the index of refraction or refractive index.

For the purposes of the present invention, the term “refractive index contrast (Δn)” is as conventionally known, and is defined as the amplitude of the sinusoidal variations in the refractive index of a material in which a plane-wave, volume hologram has been written. The refractive index may vary as: n(x)=n₀+Δn cos(Kₓ), wherein n(x) is the spatially varying refractive index, x is the position vector, K is the grating wave vector, and n₀ is the baseline refractive index of the medium. See, e.g., P. Hariharan, Optical Holography: Principles, Techniques and Applications, Cambridge University Press, Cambridge, 1991, pg. 44, the entire disclosure and contents of which is hereby incorporated by reference. The Δn of a material may be calculated from the diffraction efficiency or efficiencies of a single volume hologram or a multiplexed set of volume holograms recorded in a medium.

For the purposes of the present invention, the term “index contrast” refers to the ability of a material to create spatially distinct volumes of higher or lower indices of refraction. For example, in a higher index-contrasting monomer polymerized in a lower index-contrasting support matrix by using an interference pattern generated by crossed laser light, the pattern of the polymerized monomer mimics this interference pattern and thus creates volumes of material that have a higher refractive index (where light intensity is higher) and volumes of material that have a lower refractive index (where light intensity is lower or zero). Any refractive index contrast may allow one to control the direction that light travels by refraction or diffraction. In embodiments of the present invention, the average index contrast between the photoactive polymerizable material and the support matrix may be greater than about 0.1, for example, greater than about 0.2, more typically, greater than about 0.3. The average index contrast may be measured by direct measurement of the refractive index, molar refractive index calculations, solution refractive index methods, holographic measurement of An (most typically), etc., well known to those skilled in the art.

For the purposes of the present invention, the term “index-contrasting group” refers to those parts of the photoactive polymerizable material which may lend themselves to creating a refractive index contrast between the support matrix and the photoactive polymerizable material after exposure to a photoinitiating light source to, for example, record holograms. This refractive index contrast may be created by having the index-contrasting groups provide either higher or lower (often higher) refractive index contrast between the photopolymer resulting from the photoactive polymerizable material and the support matrix. Index-contrasting groups having a higher refractive index may be comprised of polarizable atoms and groups of atoms. For example, suitable index-contrasting groups may include one or more of bromine, chlorine, sulfur, phosphorous, benzene rings, naphthalene rings, trityl groups, biphenyls, conjugated enes or ketones, etc. For embodiments of the present invention, the index-contrasting group may often refer to the collection of index-contrasting groups that provide the majority of the index contrast for the photoactive polymerizable material. For example, a brominated benzene ring attached to a benzophenone moiety may be attached to a linker moiety and then to an acrylate moiety would contain one index-contrasting group comprising both the brominated benzene and the benzophenone group. In certain embodiments, the geometry for the index-contrasting group is such that the individual components comprising the index-contrasting group are centrally located with linking moieties or reactive groups extending away from the index-contrasting group.

For the purposes of the present invention, the term “average radius of the index-contrasting group” refers to the average radius of the Van der Waals radii of all of the collective index-contrasting groups. Such radii may be obtained by any conventional molecular modeling program.

For the purposes of the present invention, the term “average diameter of the index-contrasting group” refers to the average diameter of the Van der Waals diameter of all of the collective index-contrasting groups. Such diameters may be obtained by any conventional molecular modeling program.

For the purposes of the present invention, the terms “index-contrasting structures” or “refractive index structures” or “index structures” or “index regions” refer collectively to those volumes in a material that have a different refractive index compared to other volumes in a material.

For the purposes of the present invention, the term “reactive functional group” refers to a functional group responsible for polymerization of the photoactive polymerizable material. For example, suitable reactive functional groups may include the following: ethylenic unsaturation (i.e., one or more double bonds, such as acrylates, methacrylates, acrylamides, methacrylamides, styrenes, substituted styrenes such as methyl styrene, etc., vinyl naphthalenes, substituted vinyl naphthalenes, other vinyl polyaromatics, vinylcyclohexene, vinylcyclohexene dioxide, vinylcyclohexene monoxide, vinyl esters, vinyl ethers, vinyl carbazoles, other vinyl derivatives, cycloalkenes, cyclic ethers (e.g. epoxide, glycidyl ether, allyl glycidyl ether, etc.), cyclic carbonates, cyclic esters, dioxalanes, etc.

For the purposes of the present invention, the term “primary reactive group” refers to a primary group, as distinct from secondary or tertiary group, as this term is conventionally used in chemistry. For example, butyl acrylate is a primary acrylate, and butyl methacrylate is a primary methacrylate, but butyl methacrylate is a secondary alkene, while butyl acrylate may be referred to as a primary alkene.

For the purposes of the present invention, the term “reactive site” refers to a functional group on the photoactive polymerizable material that causes radical generation either by chain transfer or by photocleavage due to the recording light (i.e., basically a photoinitiator attached to the photoactive polymerizable material or a photoactive polymerizable material that has photoinitiating functionality). The reactive site may also be a chain transfer site for anionic or cationic reactions as well.

For the purposes of the present invention, the term “chain length” refers to the kinetic chain length, or the average degree of polymerization.

For the purposes of the present invention, the term “reactive particles” refers to nanoparticles, metal clusters, dendrimers, etc., of at least about 1 nm in size, and which may be in the range of from about 1 to about 200 nm in size, with photopolymerizable reactive groups being termed the reactive particles, thus performing as photoactive polymerizable materials in their ability to photopolymerize.

For the purposes of the present invention, the term “pseudo-step growth” refers to polymerizable materials that inherently increase in molecular weight in a step growth pattern or manner, yet use chain addition reactions (for example, radical, cationic, or anionic chain growth polymerizations). For example, thiol-acrylate polymerizations containing an excess of acrylate are a pseudo-step growth polymerization because the chains growing by both step growth and chain growth mechanisms.

For the purposes of the present invention, the term “rotaxane-like structure” refers to a mechanically-interlocked molecular architecture consisting of a dumbbell-shaped molecule that is threaded through a macrocycle or ring-like molecule. Rotaxanes may contain two or more molecular components mechanically interlocked with one another. One component is typically a dumbbell-shaped or backbone component having one or more binding sites. The remaining component(s) are circular or ring-shaped component(s) that become trapped on the dumbbell component, encircling part of that component. The two components kinetically trapped as the two end-groups of the dumbbell (often called stoppers) are larger than the internal diameter of the ring, and thus prevent dissociation (unthreading) since this would require significant distortion of the covalent bonds. A particular ring makes mechanical contact with, but is typically not chemically bonded to, the backbone. Depending on how the ring component is fabricated, the component may have one or more minimum-energy locations along the backbone. Other examples of rotaxane-like structures may include pseudo-rotaxanes, catenanes, etc.

For the purposes of the present invention, the term “catenane-like structure” refers to a mechanically-interlocked molecular architecture comprising two or more interlocked macrocyclic rings. The interlocked rings cannot be separated without breaking the covalent bonds of the macrocycles. Catenanes are conceptually related to other mechanically-interlocked molecular architectures, such as rotaxanes, molecular knots, molecular Borromean rings, etc. The term “mechanical bond” has also been coined to describe the connection between the macrocyclic rings of a catenane.

For the purposes of the present invention, the term “interpenetrating network” has the usual and conventional meaning in that two different polymers are interconnected, interwoven, wound around and through one another, etc.

For the purposes of the present invention, the term “Kramers-Kronig relationship” refers to mathematical properties which connect the real and imaginary parts of any complex function analytic in the upper half plane. For embodiments of the present invention, the Kramers-Kronig relation may be used to describe the increase in refractive index as an absorption band is approached.

For the purposes of the present invention, the term “archival life” refers to the time (e.g., in years) that the holographic medium can retain 90% of the original diffraction efficiency of the recorded hologram(s).

For the purposes of the present invention, the term “archival stability” refers to the ability of a holographic medium to retain holographic data in the presence of heat, humidity, time, other variables, etc. It is understood that substrates and other components of embodiments of optical articles of the present invention may contribute to increased archival stability of the holographic medium. Increased archival stability may also lead to increased archival life.

For the purposes of the present invention, the term “shelf life” refers to the time (e.g., in months or years) that the holographic medium (or optical article comprising same) may sit in storage before recording holograms, yet retain at least about 90% of the original dynamic range. Shelf lives of greater than about 6 months, for example, greater than about one year, more typically greater than about 2 years, may be obtained with embodiments of media/articles of the present invention.

For the purposes of the present invention, the term “linking moiety” refers to at least one atom (e.g., more than 2 atoms) forming a linear chain connecting two specified and different parts of a molecule. The specified and different parts connected may comprise the index-contrasting group and the reactive (functional) group. For example, a linker moiety may be one or more atoms forming a linear chain of atoms between an index-contrasting group and a reactive group on a molecule of a photoactive polymerizable material. Also, there may be more than one linker moiety (e.g., potentially of a different chemical composition and length).

For the purposes of the present invention, the term “partially hindered reactive group” refers to reactive (functional) groups that have some degree of steric hindrance either directly adjacent to the reactive group(s) or in close enough proximity to the reactive group(s) to reduce the reactivity of the reactive group(s) (e.g., ability to polymerize, etc.).

For the purposes of the present invention, the term “sensitivity” refers to the energy required to generate a measured amount of index contrast.

For the purposes of the present invention, the term “covalently crosslinked” refers to the conventional meaning and use of this term, wherein one or more linear polymer chains are covalently bonded to other linear polymer chains to form a 3-dimensional network.

For the purposes of the present invention, the term “shrinkage” refers to a decrease in volume that normally accompanies the transition from polymerizable material to polymer. Not all polymerizable materials produce shrinkage. For many embodiments, shrinkage may be less than about 5 volume %, for example, less than about 1 volume %, and more typically between 0 and about 0. 1 volume %. Conversely, expansion may also occur in some embodiments (e.g., as may happen with some ring opening polymerizations).

For the purposes of the present invention, the term “chain transfer” refers to interrupting the growth of a kinetic chain by formation of a new radical that may react as a new nucleus for forming a new polymeric molecular chain. Chain transfer may cause the formation of a higher proportion of shorter polymer chains, relative to polymerization reactions that occur without chain transfer. Chain transfer may also occur with cationic and anionic polymerizations.

For the purposes of the present invention, the term “reactive particle” refers to polymerizable materials which may be described as nanoparticles, dendrimers, hyperbranched polymers, metal clusters, oligomers, other molecular associations with reactive groups, etc., whereby the size of the particle is larger than about 1 nm in at least one dimension. Such reactive particles have, on average, at least one reactive group per particle, for example, reactive particles having on average at least 3 reactive groups, and more typically reactive particles having on average from 5 to 10 reactive groups. Generally, larger particles have more reactive groups. Some particles may be dynamic in nature in that the constituent parts may be in equilibrium with the particle (e.g., for some metal clusters), but other particles may be static, i.e., having a well defined and stable form.

For the purposes of the present invention, the term “nanoparticle” refers to organic or inorganic particles having a size in the range of from about 1 to about 200 nm in at least one dimension (and often in three spatial dimensions).

For the purposes of the present invention, the term “dendrimer” refers to fully synthetic macromolecules comprised of perfectly branched repeat units in layers emanating radially from a point-like core. “Dendridic” refers to molecules having structures resembling dendrimers, but which may be less perfectly structured, for example, hyperbranched star polymers.

For the purposes of the present invention, the term “optical article” refers to an article comprising a holographic medium and other optional structures, components, elements, materials, etc., such as, for example, substrates, antireflective and/or scratch resistant coatings, labeling, cartridges, hubs, etc. Examples of optical articles may include recording media, waveguides, beam or optical filters, beam steerers or deflectors, optical couplers, etc.

### Description

A. Recording Medium, Articles and Recording Holograms

Embodiments of the holographic storage media of the present invention may be formed such that holographic writing to and reading from the medium are possible. Fabrication of the holographic storage medium may involve depositing a combination, blend, mixture, etc., of the support matrix, photoactive polymerizable material, photoinitiator, etc., on a support structure, such as a substrate, or more typically positioned between a pair of (i.e., two) substrates, and using, for example, a gasket to contain the mixture. Spacers may also be used between the substrates to maintain a desired thickness for the recording medium. In applications requiring optical flatness, the liquid mixture may shrink during cooling (if a thermoplastic) or curing (if a thermoset) and thus distort the optical flatness of the article. To reduce such effects, it may be useful to place the holographic storage medium between substrates in an apparatus containing mounts, e.g., vacuum chucks, capable of being adjusted in response to changes in parallelism and/or spacing. In such an apparatus, it may be possible to monitor the parallelism in real-time by use of conventional interferometric methods, and to make any necessary adjustments to the heating/cooling process. During formation, the holographic storage medium may be supported in other ways other than by use of a substrate or substrates. More conventional polymer processing is also envisioned, e.g., closed mold formation, sheet extrusion, etc. A stratified article is also contemplated, i.e., a plurality of holographic storage medium layers disposed between respective substrates.

Embodiments of the holographic recording media of the present invention that are formed may be capable of being used in a holographic storage system, for example, the one shown in FIG. 1 and described in commonly assigned U.S. Pat. No 6,482,551 (Dhar, et al.), issued Nov. 19, 2002, the entire disclosure and contents of which is hereby incorporated by references. The amount of information capable of being stored in a holographic storage medium is proportional to the product of: the refractive index contrast, Δn, of the photorecording material, the thickness, d, of the photorecording material, etc. The An is associated with a medium before writing, but may be observed by a measurement performed after recording. Advantageously, embodiments of the holographic storage media of the present invention exhibit a An of about 3×10⁻³ or higher.

In addition to holographic storage media, examples of embodiments of other optical articles of the present invention may include beam or optical filters, beam steerers or deflectors, optical couplers, etc. (See, e.g., L. Solymar et al., Volume Holography and Volume Gratings, (Academic Press 1981), pp.: 315-27), the entire contents and disclosure of which is hereby incorporated by reference.) A beam filter separates part of an incident laser beam that is traveling along a particular angle from the rest of the beam. Specifically, the Bragg selectivity of a thick transmission hologram is able to selectively diffract light along a particular angle of incidence, while light along other angles travels undeflected through the hologram. (See, e.g., J. E. Ludman et al., “Very thick holographic nonspatial filtering of laser beams,” Optical Engineering, 36, (6), (1997), pp.: 1700 et seq., the entire contents and disclosure of which is hereby incorporated by reference.) A beam steerer is a hologram that deflects light incident at the Bragg angle. An optical coupler may be a combination of beam deflectors that steer light from a source to a target. These articles, which may also be referred to as holographic optical elements, may be fabricated by imaging a particular optical interference pattern within a recording medium, as discussed herein. Media for these holographic optical elements may be formed by the techniques discussed herein for recording media or waveguides.

The material principles discussed herein are applicable not only to hologram formation, but also to formation of optical transmission devices such as waveguides. Polymeric optical waveguides are discussed for example in B. Booth, “Optical Interconnection Polymers,” in Polymers for Lightwave and Integrated Optics, Technology and Applications, (L. A. Hornak, ed., Marcel Dekker, Inc. 1992); U.S. Pat. No. 5,292,620 (Booth et al.), issued Mar. 18, 1994; and U.S. Pat. No. 5,219,710 (Horn et al.), issued Jun. 15, 1993, the disclosures of which are hereby incorporated by reference. Essentially, the recording material may be irradiated in a desired waveguide pattern to provide refractive index contrast between the waveguide pattern and the surrounding (cladding) material. It may also be possible for exposure to be performed, for example, by a focused laser light, by use of a mask with a non-focused light source, etc. Generally, a single layer may be exposed in this manner to provide the waveguide pattern, and additional layers may be added to complete the cladding, thereby completing the waveguide. This process is discussed for example at pages 235-36 of Booth, supra, and Cols. 5 and 6 of U.S. Pat. No. 5,292,620, supra, the entire contents and disclosure of which is hereby incorporated by reference.

In one embodiment of a holographic storage medium, conventional molding techniques may be used to mold the combination, blend, mixture, etc., of the support matrix, photoactive polymerizable material, photoinitiator, etc., into a variety of shapes prior to formation of the article by cooling to room temperature. For example, the combination, blend, mixture, etc., of the support matrix, photoactive polymerizable material, photoinitiator, etc., may be molded into ridge waveguides, wherein a plurality of refractive index patterns may then be written into the molded structures. It may thereby be possible to easily form structures such as Bragg gratings. This feature may increase the breadth of applications in which such polymeric waveguides would be useful.

In another embodiment of a holographic storage medium, the support matrix may be thermoplastic and allow the holographic storage medium to behave as if it is entirely a thermoplastic. That is, the support matrix allows the holographic storage medium to be processed similar to the way that a thermoplastic is processed, i.e., molded into a shaped form, blown into a film, deposited in liquid form on a substrate or between a pair of substrates, extruded, rolled, pressed, made into a sheet of material, etc., and then allowed to harden at room temperature to take on a stable shape or form. The support matrix may comprise one or more thermoplastics. Suitable thermoplastics may include poly(vinyl acetate), poly(styrene), poly(ethylene), poly(propylene), poly(ethylene oxide), linear nylons, linear polyesters, linear polycarbonates, linear polyurethanes, poly(vinyl chloride), poly(vinyl alcohol-co-vinyl acetate), etc.

In another embodiment, the amount of thermoplastic used in the holographic storage medium may be enough that the entire holographic storage medium effectively acts as a thermoplastic for most processing purposes. The support matrix of the holographic storage medium may make up as much as about 5%, preferably as much as about 50 %, and more preferably as much as about 90% of the holographic storage medium by volume. The amount of any given support matrix in the holographic storage medium may vary based on clarity, refractive index, melting temperature, T_{g}, color, birefringence, solubility, etc. of the thermoplastic or thermoplastics that make up the binder component. Additionally, the amount of the support matrix in the holographic storage medium may vary based on the article's final form, whether it is a solid, a flexible film, or an adhesive.

In another embodiment of the holographic storage medium, the support matrix may include a telechelic thermoplastic resin—meaning that the thermoplastic polymer may be functionalized with reactive groups that covalently crosslink the thermoplastic in the support matrix with the photopolymer formed from the photoactive polymerizable material during hologram formation. Such crosslinking may make the holograms stored in the thermoplastic holographic storage medium very stable, even at elevated temperatures for extended periods of time.

Similarly, in another embodiment of the holographic storage medium wherein a thermoset is formed, the support matrix may contain functional groups that copolymerize or otherwise covalently bond with the photoactive polymerizable material used to form the photopolymer. Such support matrix attachment methods may allow for increased archival life of the recorded holograms. Suitable thermoset systems for used herein are disclosed in to U.S. Pat. No. 6,482,551 (Dhar et al.), issued Nov. 19, 2002, the entire disclosure and contents of which is hereby incorporated herein by reference.

In another embodiment of the holographic storage medium, the thermoplastic support matrix may be crosslinked noncovalently with the polymer formed upon hologram formation by using a functionalized thermoplastic polymer in the support matrix. Examples of such non-covalent bonding include ionic bonding, hydrogen bonding, dipole-dipole bonding, aromatic pi stacking, etc.

In another embodiment, the holographic storage medium may comprise at least one photoactive polymerizable material that can form holograms in the resulting photopolymer when exposed to a photoinitiating light source, such as a laser beam that is recording data pages to the holographic storage medium. The photoactive polymerizable materials may include any photoactive monomer, photoactive oligomer, or combination thereof, having the parameters as further described below, that is capable of undergoing photoinitiated polymerization, and which, in combination with the support matrix, meets the compatibility requirements of the present invention. Suitable photoactive polymerizable materials may include those which polymerize by a free-radical reaction, e.g. molecules containing ethylenic unsaturation (i.e., one or more double bonds), such as acrylates, methacrylates, acrylamides, methacrylamides, styrenes, substituted styrenes, such as methyl styrene, etc., vinyl naphthalenes, substituted vinyl naphthalenes, other vinyl polyaromatics, vinylcyclohexene, vinylcyclohexene dioxide, vinylcyclohexene monoxide, vinyl esters, vinyl ethers, vinyl carbazoles, other vinyl derivatives, cycloalkenes, cyclic ethers (e.g. epoxide, glycidyl ether, allyl glycidyl ether, etc.), cyclic carbonates, cyclic esters, dioxalanes, etc. Free-radical copolymerizable pair systems such as vinyl ether/maleimide, vinyl ether/thiol, acrylate/thiol, vinyl ether/hydroxy, etc., may also be suitable. It may also be possible to use cationically polymerizable systems; a few examples of which include vinyl ethers, alkenyl ethers, allene ethers, ketene acetals, epoxides, etc. Furthermore, anionic polymerizable systems may also be suitable herein. It may also be possible for a single photoactive polymerizable molecule to contain more than one polymerizable functional group. Other suitable photoactive polymerizable materials may also include cyclic disulfides and cyclic esters. Photoactive oligomers that may be included in the photoactive polymerizable materials to form a holographic grating upon exposure to a photoinitiating light source include oligomers such as oligomeric (ethylene sulfide) dithiol, oligomeric (phenylene sulfide) dithiol, oligomeric (bisphenol A), oligomeric (bisphenol A) diacrylate, oligomeric polyethylene with pendent vinyl ether groups, etc. The photoactive polymerizable material of the holographic storage medium may be monofunctional, difunctional, and/or multifunctional.

In addition to the at least one photoactive polymerizable material, the article comprising the holographic storage medium may contain a photoinitiator. The photoinitiator, upon exposure to relatively low levels of the recording light, chemically initiates the polymerization of the photoactive polymerizable material, thus avoiding the need for direct light-induced polymerization. The photoinitiator generally should offer a source of species that initiate polymerization of the particular photoactive polymerizable material, e.g. photoactive monomer. Typically, from about 0.1 to about 20 vol. % photoinitiator provides desirable results.

A variety of photoinitiators known to those skilled in the art and available commercially are suitable for use in the holographic storage medium. It may be advantageous to use a photoinitiator that is sensitive to light at wavelengths available from conventional laser sources, e.g., the blue and green lines of Ar⁺ (458, 488, 514 nm) and He—Cd lasers (442 nm), the green line of frequency doubled YAG lasers (532 nm), and the red lines of He—Ne (633 nm), Kr⁺ lasers (647 and 676 nm), and various diode lasers (290 to 900 nm). One advantageous free radical photoinitiator is bis(η-5-2,4-cyclopentadien-1-yl)bis[2,6-difluoro-3-(1H-pyrrol-1-yl)phenyl]titanium, available commercially from Ciba as Irgacure 784™. Another visible free-radical photoinitiator (which requires a co-initiator) is 5,7-diiodo-3-butoxy-6-fluorone, commercially available from Spectra Group Limited as H—Nu 470. Free-radical photoinitiators of dye-hydrogen donor systems are also possible. Examples of suitable dyes include eosin, rose bengal, erythrosine, and methylene blue, and suitable hydrogen donors include tertiary amines such as n-methyl diethanol amine. For blue wavelengths, any of the photoinitiators described in U.S. Pat. No. 6,780,546 (Trentler et al.), issued Aug. 24, 2004, the entire disclosure and contents of which is hereby incorporated by reference, may be useful. In the case of cationically polymerizable materials, a cationic photoinitiator may be used, such as a sulfonium salt or an iodonium salt. These cationic photoinitiator salts absorb predominantly in the UV portion of the spectrum, and are therefore typically sensitized with a sensitizer or dye to allow use of the visible portion of the spectrum. An example of an alternative visible cationic photoinitiator is (η₅-2,4-cyclopentadien-1-yl)(η₆-isopropylbenzene)-iron(II)hexafluorophosphate, available commercially from Ciba as Irgacure 261.

In many embodiments of the holographic storage medium, the photoinitiators used are sensitive to ultraviolet and visible radiation of from about 200 nm to about 1000 nm.

The holographic storage medium may also include additives such as plasticizers for altering the properties thereof including the melting point, flexibility, toughness, diffusibility of the monomers, ease of processibililty, etc. Examples of suitable plasticizers include dibutyl phthalate, poly(ethylene oxide) methyl ether, N,N-dimethylformamide, etc. Plasticizers differ from solvents in that solvents are typically evaporated whereas plasticizers are meant to remain in the holographic storage medium.

Other types of additives that may be used in the liquid mixture of the holographic storage medium are inert diffusing agents having relatively high or low refractive indices. Inert diffusing agents typically diffuse away from the hologram being formed, and can be of high or low refractive index but are typically low. Thus, when the photoactive polymerizable material is of high refractive index, the inert diffusing agent would be of low refractive index, and ideally the inert diffusing agent diffuses to the nulls in an interference pattern. Overall, the contrast of the hologram may be increased. Other additives that may be used in the mixture comprising the holographic storage medium include: pigments, fillers, nonphotoinitiating dyes, antioxidants, bleaching agents, mold releasing agents, antifoaming agents, infrared/microwave absorbers, surfactants, adhesion promoters, etc.

In one embodiment of the holographic storage medium, the photoactive polymerizable material comprises less than about 20 volume %. In other embodiments, the photoactive polymerizable material of the holographic storage medium may be less than about 10 volume %, or even less than about 5 volume %. For data storage applications, the photoactive polymerizable material is typically present at about 5 volume %. Factors affecting the amount of polymerizable content needed are generally the desired index contrast and effects from shrinkage of the photoactive polymerizable material upon recording (if it occurs), and so may be selected based on the particular application.

In one embodiment, the holographic storage medium may be used to store volatile holograms. Due to the ability to control the photopolymer chain length in the holographic storage medium, a particular mixture may be tuned to have a very general lifetime for the recorded holograms. Thus, after hologram recording, the holograms may be readable for a defined time period such as a week, a few months, years, etc. Heating the holographic storage medium may also increase such a process of hologram destruction. Examples of applications for using volatile holograms may include: rental movies, security information, tickets (or season passes), thermal history detector, time stamp, temporary personal records, etc.

In one embodiment, the holographic storage medium may be used to record permanent holograms. There are several methods to increase the permanency of recorded holograms. Many of these methods involve placing functional groups on the support matrix that allow for the attachment of the resulting photopolymer to the support matrix during cure. The attachment groups may be vinyl unsaturations, chain transfer sites, or even a polymerization retarder such as a hindered phenol derivative. Otherwise, for increased archival stability of recorded holograms, a multifunctional photoactive polymerizable material may be used which allows for crosslinking of the photopolymer, thus increasing the entanglement of the photopolymer in the support matrix. In one embodiment of holographic storage medium, both a multifunctional photoactive polymerizable material and a support matrix-attached chain transfer agent are used. In this way, the shorter chains that are caused by the polymerization retarder or chain transfer agent do not cause loss of archival life.

An optical article of the present invention may be of any thickness needed. For example the article may be thin for display holography or thick for data storage. For data storage applications, the article may be, for example, from about 1 to about 1.5 mm in thickness, and may be in the form of a film or sheet of holographic storage medium between two substrates with at least one of the substrates having an antireflective coating and may be sealed against moisture and air. An article of the present invention may also be made optically flat via the appropriate processes, such as the process described in U.S. Pat. No. 5,932,045 (Campbell et al.), issued Aug. 3, 1999, the entire disclosure and contents of which is hereby incorporated by reference.

An optical article of the present invention may be used for decorative purposes. For example, the article may be used in gift wrap or in window treatments to provide special artistic tinting or 3D designs. The article may be used in molded parts of automobiles, toys, furniture, appliances, etc. to provide decorative effects. An article of the present invention may also be used to make data storage devices of various sizes and shapes, as a block of material or as part of a coating that is coated on a substrate.

Embodiments of the holographic storage media and articles of the present invention may be used in various methods for recording one or more holograms (i.e., at least one hologram), including any method known to those skilled in the art for recording holograms in other holographic storage media. An embodiment of a method for recording at least one hologram may comprise the following steps: (a) providing an article comprising the holographic storage medium (with or without a photoinitiator for the photoactive polymerizable material); and (b) exposing the article to a photoinitiating light source (e.g. recording light) to cause the photoactive polymerizable material (e.g., by activating any photoinitiator present in the article) to form a photopolymer to thereby record at least one hologram in the holographic medium. Embodiments of methods of the present invention for recording holograms may include, for example, multiplexing holograms (e.g. polytopic, angular, phase shift, varying wavelength, varying phase code, phase correlation, etc.), as well as other techniques for recording of holograms in holographic media known to those skilled in the art. Some suitable methods for recording holograms, including multiplexing techniques, are disclosed in, for example, U.S. Pat. No. 5,703,705 (Curtis et al.), issued Dec. 30, 1997; U.S. Pat. No. 5,719,691 (Curtis et al.), issued Feb. 17, 1998; U.S. Pat. No. 5,892,601 (Curtis et al.), issued Apr. 6, 1999; U.S. Pat. No. 5,943,145 (Curtis et al.), issued Aug. 24, 1999; U.S. Pat. No. 6,191,875 (Curtis et al.), issued Feb. 20, 2001; U.S. Pat. No. 6,614,566 (Curtis et al.), issued Sep. 2, 2003; commonly assigned U.S. Pat. No. 6,697,180 to Wilson et al.), issued Feb. 24, 2004; U.S. Pat. No. 6,798,547 (Wilson et al.), issued Sep. 28, 2004; U.S. Pat. No. 6,721,076 (King et al.), issued Apr. 13, 2004; and U.S. Published Patent Application No. 2004-0179251 Anderson, et al.), published Sep. 16, 2004, the entire disclosure and contents of which are hereby incorporated by reference.

B. Photoactive polymerizable Materials Having Improved Performance

Embodiments of the photoactive polymerizable materials of the present invention may provide improved index-contrasting properties relative to the support matrix that these photoactive polymerizable materials are present in (e.g., dispersed, dissolved, dispersed, embedded, enclosed, etc., in the support matrix). These photoactive polymerizable materials may have an average index contrast (i.e., relative to the support matrix) of greater than about 0.1 (e.g., greater than about 0.2, for example, greater than about 0.3), a molecular size of at least about 1 nm in at least one spatial dimension, and comprises at least one reactive functional group and at least one index-contrasting group. The performance of embodiments of the photoactive polymerizable materials of the present invention in, for example, index contrast applications such as holographic data storage (e.g., hologram recording), holographic optical elements, waveguides, photolithography, etc., may be improved by including one or more of the following parameters: (1) a distance between at least one reactive group and at least one index-contrasting group which is at least equal to the average (i.e., Van der Waals) radius of the index-contrasting group; (2) two or more reactive groups per each molecule of photoactive polymerizable material; (3) an index-contrasting group having a strong chromophore absorption at a wavelength shorter than the recording wavelength, and (4) the photoactive polymerizable material comprises a reactive nanoparticle. Parameters 1, 2, 3 and 4 are described in further detail below.

1. Increasing Distance Between Reactive Group and Index-Contrasting Group

Increasing the distance between the reactive group and the index-contrasting group of the photoactive polymerizable material may lead to an increase in sensitivity. Additional benefits of increasing the distance between the reactive group and the index-contrasting group of the photoactive polymerizable material may include improved solubility in the support matrix, increased archival stability, etc. Embodiments of the photoactive polymerizable materials of the present invention having improved performance may include index-contrasting groups that comprise a larger portion of the volume of the photoactive polymerizable material, thus lessening the shrinkage associated with recording holograms. It has also been found that the index-contrasting group may act as a steric hindrance to the reactive site of the photoactive polymerizable material. Thus, by increasing the distance between the index-contrasting group and the reactive group (for example, by use of a linking moiety), the sensitivity (or reactivity) of the photoactive polymerizable material may be increased. Also, it has been found that the larger the index-contrasting group, the longer the distance between the index-contrasting group and the reactive group may need to be to have higher sensitivity. For example, two monomers (Chloro-trityl Monomers 1 and 2) shown below are dispersed in a GPX 1500 (hydroxyl)-WE 180 (Isocyanate) support matrix with 0.1 wt. % triphenylphosphine oxide (TPO) as the initiator and 0.5 wt. % dibutyltindilaurate and tested on a holographic planewave tester at the same molar concentration:

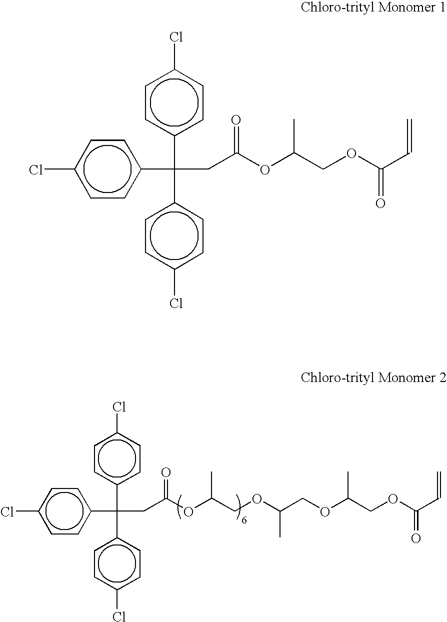

Monomer 1 above has a shorter distance between the index-contrasting group (i.e., the trityl group) and the reactive (i.e., acrylate group), when compared to Monomer 2. When tested, Monomer 2 has 10 times the sensitivity of Monomer 1. Additionally, the archival life of Monomer 2 is greatly improved over Monomer 1, suggesting that more entanglement with the support matrix has occurred. Thus, by increasing the distance between the reactive group and the index-contrasting group, the performance the photoactive polymerizable material may be improved. A suitable distance between at least one of the index-contrasting groups and at least one of the reactive groups may be at least equal to the average radius of the index-contrasting group. For example, a distance which is at least the average diameter of the index-contrasting group may be suitable, such as a distance between the index-contrasting group and the reactive group equal to from about 2 and about 4 diameters of the index-contrasting group. While the index-contrasting group of Monomers 1 and 2 is approximately round, it should be understood that other shapes of index-contrasting groups may occur, but that the average radius (or diameter) may still be used as a general guide for the distance between the reactive group and the index-contrasting group that imparts improved performance to the embodiments of the photoactive polymerizable materials of the present invention.

Additionally, the linking moiety between the reactive group and the index-contrasting group may be flexible as this may promote solubility in and entanglement with the support matrix when the photoactive polymerizable material is polymerized to become a photopolymer. It may also be advantageous to choose a linking moiety that will promote solubility in the support matrix used. Non-exhaustive examples of such linking moieties that may be used are shown below:

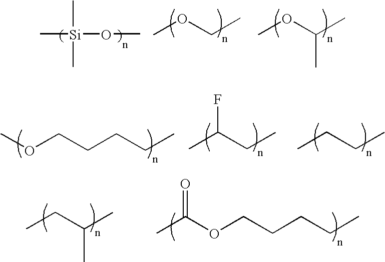

wherein n may be in the range of from 1 to 50, (e.g., from 2 to 10).

For some embodiments of the photoactive polymerizable materials of the present invention, the linking moiety itself may also contain index-contrasting group moieties, provided such moieties contribute to the solubility of the photoactive polymerizable material in the support matrix. An illustrative example of such a photoactive polymerizable material (chloro-trityl monomer with a thioether linker) is shown below:

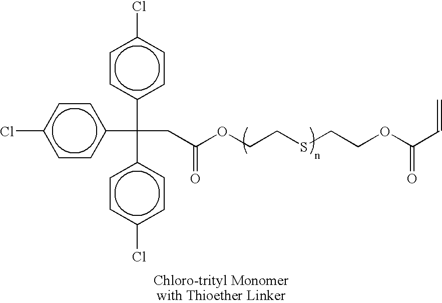

wherein n is in the range of from 1 to 50 (e.g., from 2 to 10). In the chloro-trityl monomer with thioether linker above, the linking moiety (i.e., thioether linker) is not considered a part of the index-contrasting group (i e., chloro-trityl group) even though it is contributing to the index contrast of the photoactive polymerizable material. Other non-exhaustive examples of suitable linking moieties that also have index-contrasting groups are shown below:

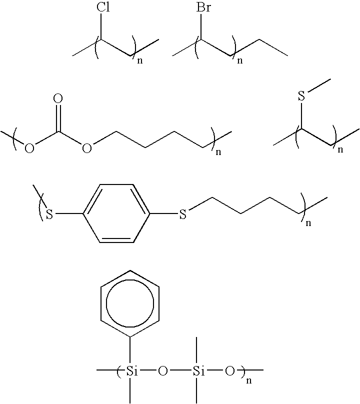

wherein n may be in the range of from 1 to 50, (e.g., from 2 to 10.

Although not required, the linking moiety having the index-contrasting group may also be flexible to promote solubility and sensitivity. Even those linking moieties shown above having, for example, carbonate and aromatic thioether linking moieties may be flexible, since these linking moieties also contain sections or atoms that are flexible. Other linking moieties that may be useful herein include amides, carbamates, etc. The above examples of linking moieties are not meant to be exhaustive, but only exemplary and illustrative of embodiments useful in the present invention. Based on the linking moieties illustrated and describe above, one skilled in the polymer art may determine other suitable linking moieties which would be flexible, would provide photoactive polymerizable materials which are soluble in a given support matrix, those which might possibly contain index-contrasting groups, etc.

2. Increasing Number of Reactive Groups per Molecule of Photoactive Material

Increasing the number of reactive groups per molecule of the photoactive polymerizable material may also increase the archival stability of the formed index-contrasting regions in the resulting photopolymer and the ultimate reactivity (sensitivity) of the photoactive polymerizable material. An increase in the number of reactive groups per molecule may also have benefits other than increasing sensitivity. For example, it has been found that having more than one reactive group per molecule may lead to enhanced archival stability of the index-contrasting region. A proposed mechanism for such embodiments of the photoactive polymerizable material of the present invention is that the resulting photopolymer is covalently crosslinked, and is thus essentially a thermoset material. Thermoset materials may be desirable as leading to increased thermal, mechanical, and chemical stability; all of which may be regarded as being desirable for many index contrast applications.

It has also been surprisingly found that increasing the number of reactive groups does not always lead to an increase in shrinkage from recording of holograms. For example, by mixing more reactive and less reactive groups (or by providing more hindered reactive groups as described below), not all of the reactive groups may react to form photopolymer chains and thus shrinkage from recording of holograms may be less than would be expected from the number of reactive groups present in the system. Examples of such mixtures of more reactive and less reactive groups may include: an acrylate group with at least one of the following groups: methacrylate, styrene, vinyl ether, or vinyl carbazole; a cyclohexeneoxide group with at least one of the following groups: a vinyl carbazole, a glycidyl ether, an allyl glycidyl ether, a cyclic ester, or a cyclic carbonate; etc.

It has further been surprisingly found that, in small molar concentrations (e.g. under about 10 volume %), multifunctional photoactive polymerizable materials (i.e., those having two or more reactive groups) may be able to crosslink enough to be held in place by the support matrix. Although not wishing to be bound by theory, it is believed that the mechanism is related to the formation of rotaxane- or catenane-like structures, or even an interpenetrating network of photopolymer around the support matrix polymer chains. If formed as rotaxane-like structures, even a low degree of polymerization (e.g., such as a degree of polymerization equal to 4), the resulting photopolymer may not be able diffuse away from the reaction site. By contrast, for monofunctional photoactive monomers, it has found that a low degree of polymerization of the resultant photopolymer may still permit diffusion away from the reaction sites, thus decreasing resolution and decreasing archival stability. Accurate mimicry of the spatial light intensity may be required for some applications of index contrast (such as holographic data storage), with such accuracy being potentially obtainable from an increase in reactive groups per molecule of the photoactive polymerizable material.

Accordingly, in these embodiments of photoactive polymerizable materials of the present invention, the photoactive polymerizable material has at least two reactive groups, for example, more than two reactive groups, per molecule of the photoactive polymerizable material. For example, these embodiments of the photoactive polymerizable materials of the present invention may have at least one very reactive group (e.g., a primary acrylate,) and at least one less reactive group (e.g., a methacrylate), for example, two or more very reactive groups and two or more much less reactive groups, per molecule of the photoactive polymerizable material such that the steric bulk of the index-contrasting group controls the degree of polymerization and keeps it, for example, in the range of from about 2 to about 30 units per photopolymer formed. The degree of polymerization may be determined by the volume size of the photoactive polymerizable material. For example, if the photoactive polymerizable material is relatively large (e.g., from about 10 to about 200 nm), a smaller degree of polymerization may be desired. (Limiting the degree of polymerization may limit scatter and phase separation.) Conversely, if the photoactive polymerizable material is relatively small (e.g., from about 1 to about 10 nm), then a larger degree of polymerization may be desired. The overall geometry of the molecules of the photoactive polymerizable material is desirably spherical in shape, but may also be in the form of ovals, short rods, etc.

3. Index-Contrasting Group with Strong Chromophore Absorption at Wavelength Shorter than Recording Wavelength

Choosing an index-contrasting group that has a strong chromophore absorption at a wavelength shorter than (e.g. just less than) the recording wavelength, and thus increasing the refractive index of the index-contrasting group (e.g. by using the Kramers-Kronig relationship) may also improve the performance of embodiments of the photoactive polymerizable materials of the present invention. In particular, choosing such an index-contrasting group has been found to increase the potential contrast of a photoactive polymerizable material, but without an increase in shrinkage or volume of the photopolymer resulting from such a material (relative to other photoactive polymerizable materials that do not have such an index-contrasting group). The effect of an increased refractive index imparted by such index contrasting groups (e.g., by using the Kramers-Kronig relationship) may be accomplished several ways. For example, charge transfer absorptions, band gaps in semiconductors and metals, metal-ligand absorptions, etc., may be used in the photoactive polymerizable material to impart an increased refractive index. Although there are other types of absorptions that may be used to impart an increased refractive index, charge transfer absorptions, band gaps in semiconductors and metals, and metal-ligand absorptions tend to be very strong, with molar extinctions of, for example, greater than about 10,000, and are tunable in wavelength, but absorptions achieving even higher molar extinctions of greater than about 50,000, for example, at least about 100,000, may be possible and even more desirable. By proper tuning to one of these absorptions, a subsequent increase in the refractive index of the photoactive polymerizable material may be realized. To realize this increase in the refractive index, it may be desirable to be on the longer wavelength side of the absorption band. Ideally, the absorption band is very narrow and very strong. The recording wavelength is also selected to be at longer wavelengths than the peak absorption, e.g., on the tail of the absorption. There may also be a trade off, however; for some uses such as high density data storage applications, such that an increase in absorption at the recording or read out wavelength may not desirable. In such uses, it may be desirable that the absorption of the photoactive polymerizable material be below about 20%, (e.g., below about 10%), and in the range of from about 2 to about 5% absorption for a 2 mm thick sample containing the photoactive polymerizable material. It should also be understood that absorption may be thickness dependent for a given concentration of photoactive polymerizable material. Applications that use thinner media may be able go to a higher molar absorbance (and consequently higher refractive indices) at the readout wavelength. See “Kramers-Kronig constrained variational analysis of optical spectra”; A. B. Kuzmenko, Rev. Sci. Instrum., 76, 2005, 083108; “Mid-infared optical properties of a polymer film: comparision between classical molecular simulations, spectrometry, and ellipsometry techniques”; A. Soldera and E. Monterrat, Polymer, 43, 2002, 6027-6035, the entire disclosure and contents of which are hereby incorporated by reference.

4. Reactive Nanoparticles

Reactive particles comprising photoactive polymerizable materials may also lead to enhanced sensitivity, enhanced dynamic range, reduced scatter, etc. It has been found that crystalline or amorphous clusters of metals, metal oxides, semiconductor materials, insulators (e.g., diamond), inorganic and organic-inorganic salts, and other inorganics, organic particles such as dendrimers, oligomers, hyperbranched polymers, and polymer spheres, etc., may allow for a very high molecular bond refraction per volume of photoactive polymerizable material, which may lead to a higher index contrast and sensitivity. Additionally, these structures may be spherical in shape which may allow for faster diffusion through the support matrix (relative to other shapes of similar volume). Photoactive polymerizable materials in the form of reactive nanoparticles may sometimes not be considered distinct molecules (e.g., may be considered as an association of molecules or nonmolecular solids), however, for the purposes of index contrast applications, these types of materials may be very useful when they have sizes less than about 200 nm (for example, less than about 100 nm and more typically less than about 10 nm) in the longest spatial dimension. The tendency to scatter may be determined by particle size and refractive index, refractive index of the support matrix, and the wavelength of light. Larger sizes may lead to scattering of light and thus may not be as useful for some index contrast applications. Yet, larger particles may also be permissible for longer wavelengths and lesser index contrast between the particle and support matrix. Accordingly, smaller sizes may be used permit a more facile diffusion in the support matrix (especially if crosslinked or rigid).

For embodiments of photoactive polymerizable materials of the present invention in the form of reactive particles that have refractive indices greater than or less than about 0.3 relative to the support matrix refractive index (i.e. differing from or by about 0.3), it may be necessary to limit the degree of polymerization of the photoactive polymerizable material. If the degree of polymerization, or especially if the size of the resultant photopolymer becomes greater than about 50 nm, the photopolymer may scatter light. Therefore, using any of the techniques mentioned herein which may limit the size of the photopolymer may also reduce subsequent scatter. Depending on the refractive index of the photopolymer (and the wavelength of the recording light), the particular size limit of the photopolymer may be determined, and a chain transfer agent, linking moiety length or degree of reactivity of the reactive group (or any combination of these three) may then be used to control the size of the photopolymer.

In another embodiment of such photoactive polymerizable materials, the high index contrast particle may have a shell of lower contrast material. Nanoparticles may be terminated or capped on the outer surface by chemical moieties differing from the repeating units of the core of the nanoparticle. Such moieties may include surfactants, ligands, covalently or ionically bonded or grafted organics, nonbonded or electrostatically attracted polymer encapsulants, nonmolecular inorganic shells (as in core/shell nanoparticles), other surface reconstructions, etc. These caps may be of lower refractive index than the nanoparticle (for nanoparticles of refractive index larger than the support matrix) itself and may be chosen to impart dispersibility, miscibility, solubility, etc., in a medium or matrix, and also to minimize or prevent cluster aggregation and agglomeration or to otherwise stabilize the nanoparticles. Together, the particles and caps may comprise the reactive particle. Multiple types of caps may be employed on a single particle, and the caps may comprise in whole or in part the photoreactive groups of the particles. The reactive groups may also be oriented to the periphery of the reactive particle. The caps may also possess the same refractive index as the support matrix, and may also possess a refractive index gradated from the particle core towards that of the support matrix, as this may tend to blur the index boundary between the particle and the matrix and thereby help diminish light scatter. Also, in certain embodiments, the thickness of the shell material around the photoactive core material may be less than about 4 diameters of the core material, for example, less than about 2 diameters, and more typically a diameter of from about 0.25 to about 0.5 of the diameter of the core material. In general, the larger the index contrast between the photoactive core material and the support matrix, the thicker the shell should be to prevent undesired scatter. It should be understood that the particle may also be of a lower refractive index compared to the support matrix, in which case, the shell would be of a higher refractive index than the core. For making reactive particles, see “Recent Advances in the Liquid-Phase Synthesis of Inorganic Nanoparticles”; Brian L. Cushing, et. al., Chem. Rev. 2004, 104, 3893-3946; “Shape Control of Semiconductor and Metal Oxide Nanocrystals through Nonhydrolytic Colloidal Routes”; Young-wook Jun, et. al., Angewandte Chemie Int. Ed., 2006, 45, 3414-3439; “Synthesis Routes for Large Volumes of Nanoparticles”; Ombretta Masala and Ram Seshadri, Annu. Rev. Mater. Res., 2004, 34, 41-81.; “Concepts for the incorporation of inorganic building blocks into organic polymers on a nanoscale”; Guido Kickelbick, Prog. Polym. Sci., 28, 2003, 83-114, the entire disclosures and contents of which are herein incorporate by reference.

In another embodiment, polymerization of the reactive particles may be partially or completely restricted, so that only single units react (e.g., a reactive functional group of the reactive particle binds as a single unit to a corresponding group of the support matrix). Large particle size and refractive index may result in high index contrast and write sensitivity in the absence of a photoamplification mechanism such as a polymerization reaction. In such an event, the possible reactive functional groups of the reactive particles (photoactive polymerizable material), may be expanded from those that may undergo radical, cationic, or anionic chain reactions, to any chemical reaction capable of forming a chemical bond (e.g., covalent, ionic, coordinative, H-bond, etc). In particular, it may be desirable to form a bond to a functional moiety of the matrix, as described in U.S. Published Patent Application 2004-0027625 (Trentler et al.), published Feb. 12, 2004, the entire disclosure and content of which is hereby incorporated by reference. Photocycladdition reactions may be particularly suitable reactions, such as between anthracenes, acenaphthylenes, phenanthrenes, other polyaromatic hydrocarbons, etc., photo-Diels-Alder reactions, other concerted or nonconcerted cyclizations of compounds possessing double bonds (2+2, 4+4, 4+2, 3+2, etc.), etc.

Combinations of more than one of the above-described parameters 1, 2, 3 or 4 may also be used in the embodiments of photoactive polymerizable materials of the present inventions to enhance the performance of the photoactive polymerizable material. For example, embodiments of the photoactive polymerizable material may comprise nanoparticulate metal oxides and metals (parameter 4 above) having strong absorptions that are both tunable and appropriately strong for an increase in refractive index (parameter 3 above), thereby creating smaller photoactive molecules with larger index contrast potential. Also, embodiments of photoactive polymerizable materials having increased distance between index-contrasting and reactive groups (parameter 1 above) formed as reactive nanoparticles (parameter 4 above), with or without index-contrasting groups having a strong chromophore absorption having a wavelength shorter than the recording wavelength (parameter 3 above) may also provide a very sensitive, high contrast photoactive polymerizable materials. Alternatively, embodiments of photoactive polymerizable materials which combine parameters 1, 4, and 3 above may also be formed so that index contrast and sensitivity are relatively high, yet with relatively low scatter.

One or more of the above-described parameters 1, 2, 3 or 4 may also be used combinations with other parameters for enhancing the performance of embodiments of photoactive polymerizable materials of the present invention. These other parameters which may lead to increased performance of these photoactive polymerizable materials may include: (a) increasing molecular bond refraction per volume of the molecule, thus allowing a high diffraction efficiency and increased dynamic range; (b) increasing the volume of the molecule of the photoactive polymerizable material compared to the reactive group used to form the photopolymer, thus decreasing the shrinkage associated with recording (which may be less of a factor with ring opening reactions); (c) increasing the number of index-contrasting groups per molecule of the photoactive polymerizable material which is a method for accomplishing both parameters (a) and (b); (d) increasing the solubility of both photoactive polymerizable material and its resulting photopolymer in the support matrix, thereby decreasing scatter that may be associated with the formation of the photopolymer within a support matrix; and (e) using two chemistry approaches (i.e., two component systems), i.e., wherein the chemistry used to form the support matrix is substantially independent of the chemistry used by the photoactive polymerizable materials to record refractive index structures so that the index contrast between the recording chemistry and the support matrix may be maximized.

In certain embodiments of photoactive polymerizable materials of the present invention, one or more of the primary reactive groups (e.g., epoxides, acrylates (e.g., primary acrylates), methacrylates, acrylamides, etc.) may also be altered or modified to increase reactivity, thus increasing sensitivity. When the reactive group is less sterically hindered than another (secondary) reactive group (for a given “class” of reactive groups; the “class” may be an acrylate, an epoxide, a cyclohexylepoxide, a methacrylate, a stryryl, etc.) of the photoactive polymerizable material, sensitivity of the photoactive polymerizable material may be increased. For example, sensitivity of the photoactive polymerizable material may be tuned up or down by the addition (or removal) of steric hindrance at or very near the reactive site.

In certain embodiments of photoactive polymerizable materials of the present invention, the functional group(s) on the photoactive polymerizable material may be selected to affect sensitivity, solubility in the support matrix, etc. In addition to controlling the sterics of the photoactive polymerizable materials, functional groups may be added to alter the reactivity thereof For example, it has been found that adding a chain transfer functionality at a reactive site to the photoactive polymerizable material may enable shorter chain lengths to be formed or created, yet allow for crosslinking reactions. In addition, linking moieties, for example, thioether linking moieties, may not only be beneficial as a linking moiety; but may also be beneficial as chain transfer sites which may decrease the degree of polymerization and thus lead to a pseudo-step growth mechanism with little loss in sensitivity. Such chain transfer functionalities may be achieved, for example, by use of an aliphatic thioether, disulfide, aliphatic phosphorous, aliphatic tertiary amine, etc. Furthermore, addition of functional groups to the photoactive polymerizable material that mimic the support matrix may allow for a greater solubility of the photoactive polymerizable material (and the resulting photopolymer therefrom). In certain embodiments, a photoinitiator may be included on the photoactive polymerizable material, which may also allow for crosslinking by effectively adding a reactive site thereto.

In certain embodiments of photoactive polymerizable material of the present invention, the photoactive polymerizable material may be structured such that the reactive groups are partially hindered by steric factors, thus allowing greater control of the degree of polymerization. It has been discovered that by having sterically hindered reactive sites, more reactive sites per molecule may be used without a proportional increase in shrinkage. This may be particularly advantageous for photoactive polymerizable materials that undergo chain polymerization. Using this parameter, one may obtain photoactive polymerizable materials that normally undergo chain polymerization, but instead undergo pseudo-step growth. With pseudo-step growth, the molecular weight of the resulting photoactive photopolymer remains relatively low. Lower molecular weight photopolymers may increase the likelihood that the photopolymer remains soluble in the support matrix. Solubility of the photopolymer in the support matrix may ensure that the photopolymer will not form scatter centers from phase separation. But if the molecular weight of the photopolymer is too low, the archival stability of the resulting index structure may suffer because insufficient entanglement may occur with the support matrix. By adjusting the relative size of the index-contrasting group(s), relative to the linking moiety length, the ability of the photoactive polymerizable material to form longer chain lengths may be reduced. By adjusting the relative size of the index-contrasting group(s), relative to the linking moiety, the effective chain length of the resulting photopolymer may also be affected. In addition, another effect from increasing the steric bulk around the reactive group(s) is that the sensitivity may decrease because fewer reactions per chain are occurring.

In certain embodiments of photoactive polymerizable material of the present invention, a mixture of hindered and unhindered reactive groups may be used to control the degree of polymerization and sensitivity. The hindered reactive groups may be less likely to be fully polymerized, and thus shrinkage may be reduced from what would be expected by having more reactive groups, as illustrated by (Chloro-Trityl Sorbitol) Monomers 1 and 2 shown below:

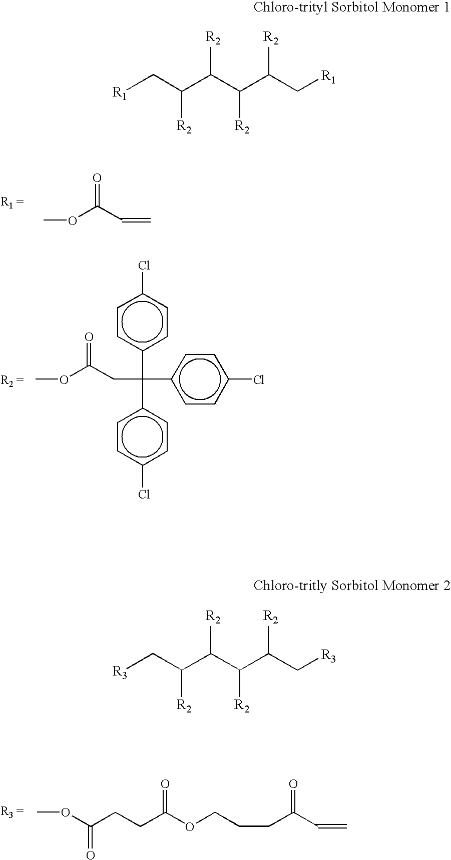

The physical structure of the above Monomers 1 and 2 resemble spheres. Monomer 1 has been found to have an order of magnitude less sensitivity than Monomer 2; and additionally has been found to have ⅓ less shrinkage relative to Monomer 2. This suggests that not all of the acrylate groups on Monomer 1 are polymerized into photopolymer chains when compared to Monomer 2. That the degree of polymerization is least for Monomer 1 is also indicated by neat polymerization of the two monomers, whereby Monomer 1 is significantly less crosslinked compared to Monomer 2, as determined by solvent extraction of respective soluble polymers.

### EXAMPLES

Chloro-trityl sorbitol (e.g., Monomers 1 and 2) above may be made by using a DCC coupling reaction. First, a slight excess of an acrylate acid (see compound above with R₁ and R₃ groups) is used relative to the primary hydroxyls on the sorbitol. The primary hydroxyls may be preferentially reacted over the secondary hydroxyls. Column chromatography may be used to purify the first resultant diacrylate. Then, a second DCC coupling reaction may be used to react trityl propionic acid (see compound above with R₂ groups) with the resultant acrylate from the first DCC coupling reaction. Again, column chromatography may be used to purify the resultant diacrylates from the second DCC coupling reaction.

Other chloro-trityl monomers illustrated above (e.g., chloro-trityl monomer with thioether linker) may be prepared by similar methods with appropriate modifications known to those skilled in the art.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A composition comprising at least one a photoactive index-contrasting polymerizable material, wherein the photoactive polymerizable material comprises at least one reactive functional group and at least one index-contrasting group, and wherein the photoactive polymerizable material includes one or more of the following parameters: (1) a distance between at least one reactive group and at least one index-contrasting group which is at least to the average radius of the index-contrasting group; (2) two or more reactive groups per each molecule of photoactive polymerizable material; (3) an index-contrasting group having a strong chromophore absorption at a wavelength shorter than the recording wavelength, or (4) the photoactive polymerizable material comprises a reactive nanoparticle.

2. The composition of claim 1, wherein the photoactive polymerizable material has the parameter of a distance between at least one reactive group and at least one index-contrasting group which is at least equal to the average radius of the index-contrasting group.

3. The composition of claim 2, wherein the distance between the at least one reactive group and at least one index-contrasting group is at least equal to the average diameter of the index-contrasting group.

4. The composition of claim 3, wherein the distance between the at least one reactive group and at least one index-contrasting group is equal to from about 2 and about 4 diameters of the index-contrasting group.

5. The composition of claim 2, wherein the photoactive polymerizable material comprises a linking moiety between the at least one reactive group and at least one index-contrasting group.

6. The composition of claim 5, wherein the linking moiety is selected from the following linking moieties: 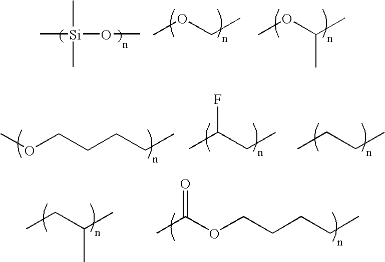
wherein n is in the range of from 1 to 50.

7. The composition of claim 6, wherein n is in the range of form 2 to 10.

8. The composition of claim 5, wherein the linking moiety is selected from the following linking moieties: 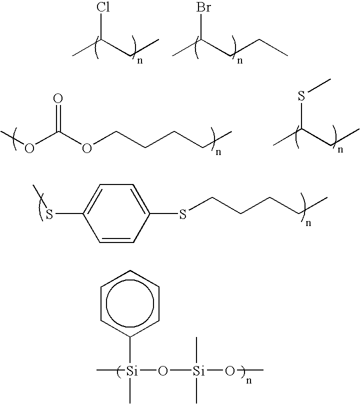
wherein n is in the range of from 1 to 50.

9. The composition of claim 8, wherein n is in the range of form 2 to 10.

10. The composition of claim 1, wherein the photoactive polymerizable material has the parameter of two or more reactive groups per each molecule of photoactive polymerizable material.

11. The composition of claim 10, wherein the photoactive polymerizable material has the more than two reactive groups per each molecule of photoactive polymerizable material.

12. The composition of claim 10, wherein the photoactive polymerizable material has at least one very reactive group and at least one less reactive group per each molecule of photoactive polymerizable material.

13. The composition of claim 12, wherein the photoactive polymerizable material has two or more very reactive groups and two or more less reactive groups per each molecule of photoactive polymerizable material.

14. The composition of claim 1, wherein the photoactive polymerizable material has the parameter of an index-contrasting group having a strong chromophore absorption at a wavelength shorter than the recording wavelength.

15. The composition of claim 14, wherein the index-contrasting group has a chromophore absorption with a molar extinction of greater than about 10,000.

16. The composition of claim 15, wherein the index-contrasting group has a chromophore absorption with a molar extinction of greater than about 50,000.

17. The composition of claim 1, wherein the photoactive polymerizable material comprises a reactive nanoparticle.

18. The composition of claim 17, wherein the reactive nanoparticles have a particle size of less than about 200 nm.

19. The composition of claim 18, wherein the reactive nanoparticles have a particle size of less than about 100 nm.

20. The composition of claim 19, wherein the reactive nanoparticles have a particle size of less than about 20 nm.

21. The composition of claim 17, wherein the reactive nanoparticles comprise a shell of lower contrast material.

22. The composition of claim 1, wherein the photoactive polymerizable material comprises a monomer having the following formula:

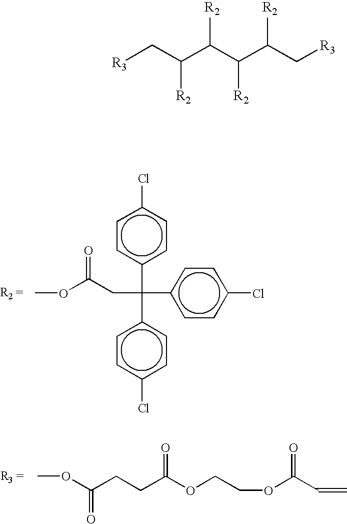

23. The composition of claim 1, wherein the photoactive polymerizable material comprises a monomer having the following formula: 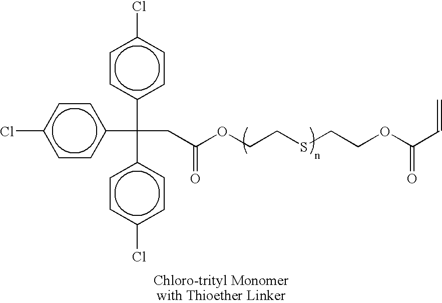
wherein n is in the range of from 1 to 50.

24. The composition of claim 1, wherein the reactive group comprises at least one of the following groups: an unsaturated double bond, a cyclic ether, a cyclic carbonate, a cyclic ester, or a dioxalane.

25. The composition of claim 1, wherein the reactive group comprises a mixture of an acrylate group with at least one of the following groups: methacrylate, styrene, vinyl ether, or vinyl carbazole.

26. The composition of claim 1, wherein the reactive group comprises a mixture of a cyclohexeneoxide group with at least one of the following groups: a vinyl carbazole, a glycidyl ether, an allyl glycidyl ether, a cyclic ester, or a cyclic carbonate.

27. An article comprising a support matrix and at least one index-contrasting photoactive polymerizable material present in the support matrix, wherein the photoactive polymerizable material has an average index contrast of greater than about 0.1, a molecular size of at least about 1 nm in at least one spatial dimension, wherein the polymerizable material comprises at least one reactive functional group and at least one index-contrasting group, wherein the index contrasting group is substantially absent from the support matrix, and wherein the photoactive polymerizable material includes one or more of the following parameters: (1) a distance between at least one reactive group and at least one index-contrasting group which is at least to the average radius of the index-contrasting group; (2) two or more reactive groups per each molecule of photoactive polymerizable material; (3) an index-contrasting group having a strong chromophore absorption at a wavelength shorter than the recording wavelength, or (4) the photoactive polymerizable material comprises a reactive nanoparticle.

28. The article of claim 27, wherein the article comprises a holographic storage medium comprising the support matrix and the photoactive polymerizable material.

29. The article of claim 28, wherein the support matrix comprises a thermoset polymer.

30. The article of claim 28 wherein the support matrix comprises a thermoplastic.

31. The article of claim 28, which further comprises a pair of substrates and wherein the holographic medium is positioned between the substrates.

32. The article of claim 31, wherein each of the substrates comprises a glass plate.

33. The article of claim 31, wherein each of the substrates comprises a plastic plate.

34. The article of claim 28, wherein the holographic storage medium further comprises a photoinitiator for the photoactive polymerizable material.

35. The article of claim 27, which is in the form of an optical waveguide.

36. The article of claim 27, wherein the photoactive polymerizable material has the parameter of a distance between at least one reactive group and at least one index-contrasting group which is at least equal to the average radius of the index-contrasting group.

37. The article of claim 36, wherein the distance between the at least one reactive group and at least one index-contrasting group is at least equal to the average diameter of the index-contrasting group.

38. The article of claim 37, wherein the distance between the at least one reactive group and at least one index-contrasting group is equal to from about 2 and about 4 diameters of the index-contrasting group.

39. The article of claim 37, wherein the photoactive polymerizable material comprises a linking moiety between the at least one reactive group and at least one index-contrasting group.

40. The article of claim 39, wherein the linking moiety is selected from the following linking moieties: 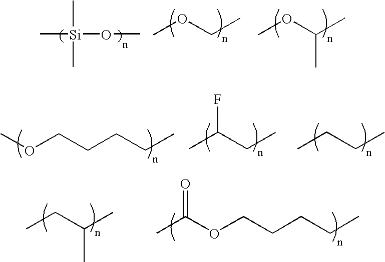
wherein n is in the range of from 1 to 50.

41. The article of claim 39, wherein the linking moiety is selected from the following linking moieties: 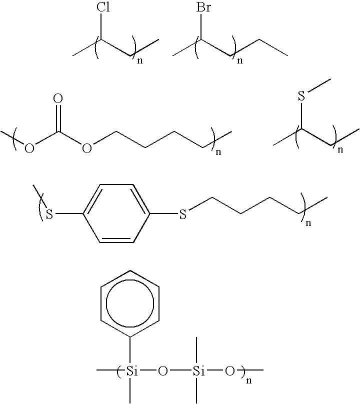
wherein n is in the range of from 1 to 50.

42. The article of claim 27, wherein the photoactive polymerizable material has the parameter of two or more reactive groups per each molecule of photoactive polymerizable material.

43. The article of claim 42, wherein the photoactive polymerizable material has the more than two reactive groups per each molecule of photoactive polymerizable material.

44. The article of claim 43, wherein the photoactive polymerizable material has at least one very reactive group and at least one less reactive group per each molecule of photoactive polymerizable material.

45. The article of claim 44, wherein the photoactive polymerizable material has two or more very reactive groups and two or more less reactive groups per each molecule of photoactive polymerizable material.

46. The article of claim 27, wherein the photoactive polymerizable material has the parameter of an index-contrasting group having a strong chromophore absorption at a wavelength shorter than the recording wavelength.

47. The article of claim 46, wherein the index-contrasting group has a chromophore absorption with a molar extinction of greater than about 10,000.

48. The article of claim 47, wherein the index-contrasting group has a chromophore absorption with a molar extinction of greater than about 50,000.

49. The article of claim 27, wherein the photoactive polymerizable material comprises a reactive nanoparticle.

50. The article of claim 49, wherein the reactive nanoparticles have a particle size of less than about 200 nm.

51. The article of claim 50, wherein the reactive nanoparticles have a particle size of less than about 100 nm.

52. The article of claim 51, wherein the reactive nanoparticles have a particle size of less than about 20 nm.

53. The article of claim 49, wherein the reactive nanoparticles comprise a shell of lower contrast material.

54. The article of claim 27, wherein the photoactive polymerizable material comprises a monomer having the following formula:

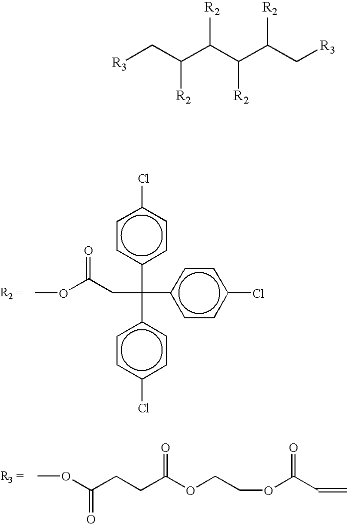

55. The article of claim 27, wherein the photoactive polymerizable material comprises a monomer having the following formula: 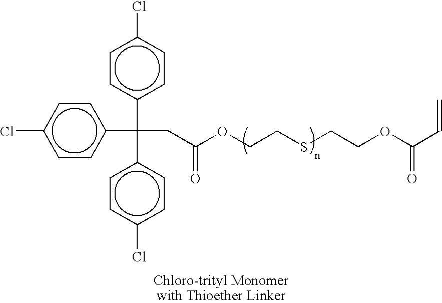
wherein n is in the range of from 1 to 50.

56. The article of claim 27, wherein the reactive group comprises at least one of the following groups: an unsaturated double bond, a cyclic ether, a cyclic carbonate, a cyclic ester, or a dioxalane.

57. The article of claim 27, wherein the reactive group comprises a mixture of an acrylate group with at least one of the following groups: methacrylate, styrene, vinyl ether, or vinyl carbazole.

58. The article of claim 27, wherein the reactive group comprises a mixture of a cyclohexeneoxide group with at least one of the following groups: a vinyl carbazole, a glycidyl ether, an allyl glycidyl ether, a cyclic ester, or a cyclic carbonate.

59. The article of claim 27, wherein the photoactive polymerizable material is dispersed in the support matrix.

60. A method which comprises the following steps:
a. providing an article comprising a holographic storage medium, wherein the holographic medium comprises: a support matrix, and at least one index-contrasting photoactive polymerizable material present in the support matrix, wherein the photoactive polymerizable material has an average index contrast of greater than about 0.1, a molecular size of at least about 1 nm in at least one spatial dimension, wherein the polymerizable material comprises at least one reactive functional group and at least one index-contrasting group, wherein the index-contrasting group is substantially absent from the support matrix, and wherein the photoactive polymerizable material includes one or more of the following parameters: (1) a distance between at least one reactive group and at least one index-contrasting group which is at least to the average radius of the index-contrasting group; (2) two or more reactive groups per each molecule of photoactive polymerizable material; (3) an index-contrasting group having a strong chromophore absorption at a wavelength shorter than the recording wavelength, or (4) the photoactive polymerizable material comprises a reactive nanoparticles; and
b. exposing the article to a photoinitiating light source to cause the photoactive polymerizable material to form a photopolymer to thereby record at least one hologram in the holographic medium.

61. The method of claim 60, wherein the article of step (a) further comprises a photoinitiator for the photoactive polymerizable material, and wherein the photoinitiating light source of step (b) activates the photoinitiator to cause the photoactive polymerizable material to form the photopolymer.

62. The method of claim 60, wherein the photoinitiating light source of step (b) comprises recording light.

63. The method of claim 62, wherein holographic data is recorded in the holographic medium in step (b).
